(19) United States
(12) Patent Application Publication
(10) Pub. No.: US 2010/0094728 A1
(43) Pub. Date: Apr. 15, 2010

(54) METHOD AND SYSTEM FOR DISTRIBUTING MEDIA CONTENT AND PROCESSING PAYMENTS AND/OR VOLUNTARY DATA COLLECTION

(76) Inventors: James Denning, Los Angeles, CA (US); Michael Buehler, Santa Monica, CA (US); Beau McCoy-Markowitz, New Port Beach, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/559,314

(22) Filed: Sep. 14, 2009

Related U.S. Application Data
(60) Provisional application No. 61/096,731, filed on Sep. 12, 2008.

(51) Int. Cl. G06Q 30/00; G06Q 50/00; G06Q 20/00; G06F 3/048; G06F 15/16

(52) U.S. Cl. 705/27; 715/716; 709/203; 715/738

(57) ABSTRACT

A system and method for distributing media content and processing payments have been described. According to one embodiment, a computer-implemented method, comprises receiving a request to view a media asset. A trailer associated with the media asset is provided for display on a remote client. An interface is provided on the remote client for receiving a request to transfer money and information to the poster of the media asset

The present application claims the benefit of and priority to U.S. Provisional Patent Application No. 61/096,731 entitled “METHOD AND SYSTEM FOR DISTRIBUTING MEDIA CONTENT AND PROCESSING PAYMENTS” and filed on Sep. 12, 2008, and is hereby, incorporated by reference.

### FIELD

The field of the invention relates generally to computer systems. In particular, the present method and system is directed to distributing media content and processing payments and/or voluntary data collection.

### BACKGROUND

Media creators and providers have consistently sought a method to monetize their distributed online content. Traditional e-commerce functionality is typically restricted to being performed within the site where the transaction was created. Existing media distribution systems (embedded players) do not incorporate functionality required to perform e-commerce transactions.

Websites and services such as YouTube, Vimeo and playlist.com allow media to be transmitted and presented via the Internet. These media delivery systems do not have internal mechanisms for conducting commerce related to the media content, particularly when that media is embedded outside the host site or service.

E-commerce sites such as Amazon.com and eBay.com offer goods and services for sale; however these sales may only be conducted within the host site or service. Rich media delivery associated with these products or services must typically be hosted outside the e-commerce site and have no inherent link to the associated product. As such, when these media files are shared, distributed and embedded, the association to the affiliated product is not preserved, and the file does not serve its original purpose: fostering an e-commerce transaction.

### SUMMARY

A system and method for distributing media content and processing payments are described. According to one embodiment, a computer-implemented method, comprises receiving a request to view a media asset. A trailer associated with the media asset is provided for display on a remote client. An interface is provided on the remote client for receiving a request to transfer money and information to the poster of the media asset.

The above and other preferred features, including various novel details of implementation and combination of elements, will now be more particularly described with reference to the accompanying drawings and pointed out in the claims. It will be understood that the particular methods and circuits described herein are shown using illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and, together with the general description given above and the detailed description of the preferred embodiment given below, serve to explain and teach the principles of the present invention.

FIG. 1 illustrates an exemplary media content distribution system, according to one embodiment;

FIG. 2 illustrates an exemplary web server, according to one embodiment;

FIG. 3 illustrates an exemplary media player functionality, according to one embodiment;

FIG. 4 illustrates an exemplary web site functionality, according to one embodiment;

FIG. 5 illustrates an exemplary billing system and payment process, according to one embodiment;

FIG. 6 illustrates an exemplary database schema, according to one embodiment;

FIG. 6 illustrates an exemplary data services process, according to one embodiment;

FIG. 7 illustrates an exemplary process for converting content, according to one embodiment;

FIG. 8 illustrates an exemplary application server logic, according to one embodiment; and

FIG. 9 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

According to one embodiment, a computer-implemented method, the system comprises receiving a request to view a media asset. The media asset is provided for display on a remote client. An interface is provided on the remote client, through which users have the opportunity to make payment and donation transactions, or perform additional operations, including lead generation. Lead generation may include soliciting data from end users to collect signatures for a campaign, sign up for an upcoming trade show, or participate in a test group. The media asset may describe deliverables in the form of a media file (text, pdf, image, executable, podcast) or even access to a website, and the later delivery of goods and services.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

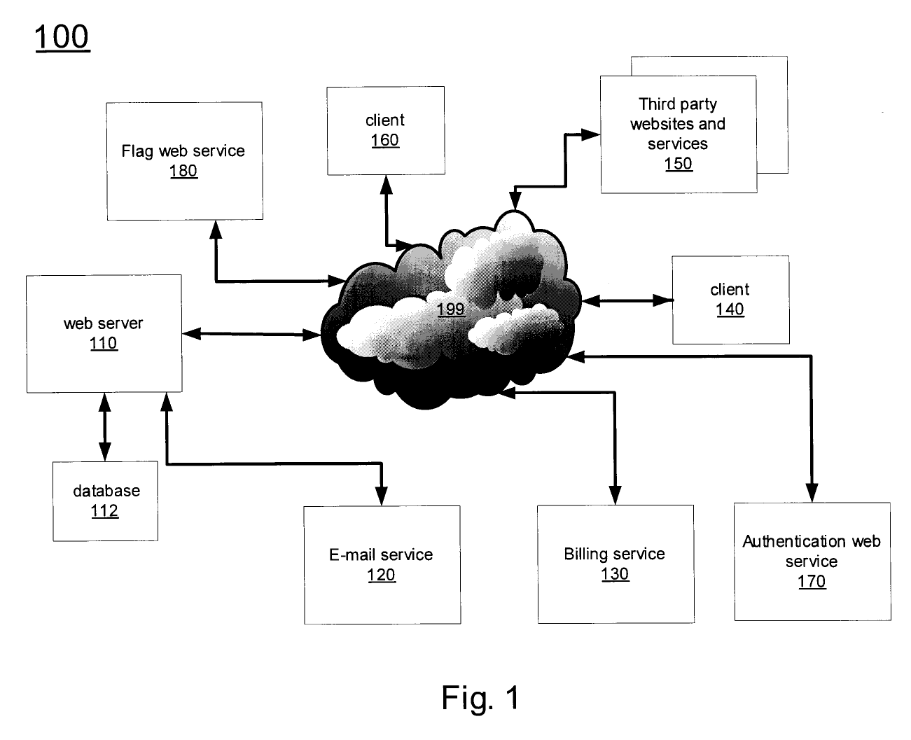

FIG. 1 illustrates an exemplary media content distribution system, according to one embodiment. Content delivery system 100 includes a number of network nodes interconnected by a network 199, such as the Internet.

Web server 110 enables a number of web services, such as a sharing e-mail web service, a content data web service, a content list web service, a comments web service, an authentication web service, a rating web service and a flagging web service. Sharing e-mail web service 120 sends an email containing an embedded player, thumbnail (static or animated), a description and a direct link to the supplied email address. A collection of web services supply various pieces of data, such as content description, title, customization options as relevant, pricing/recommended donation levels, donation goals, playback restrictions, location and other data, for a specific piece of content. Comments web service displays and posts comments for a specific piece of content. Authentication web service 170 authenticates a user login. It is used by the media player, system web site and external APIs (Application Programming Interfaces). Rate web service accepts user input of a rating for the video and increments to ratings total value, as well as the counter containing the number of ratings. When the content is displayed again, the ratings total value and the number of ratings will be used to generate the average rating. Flag web service 180 accepts user input that flags content as offensive, mature or pirated or otherwise unsuitable for distribution. If the ratio of total number of flags to the total number of views exceeds a certain percentage threshold, this web service will send a notification alerting the present system, and the content poster of the potential offense.

Database 112 stores information gathered, generated, and processed by web server 110 and all other web services that comprise the system and may be built on LAMP (Linux, Apache, MySQL, PHP) or a similar platform.

Third party web sites and services 150 may embed content either directly by way of a sharing web service, or indirectly by way of a special purpose web application (such as for Facebook, which does not allow direct embedding of video on user editable pages). This content is inclusive of the entire media player framework which is inextricably linked to transaction or lead generation functionality contained therein.

Content delivery system 100 also includes a client 140 connected to the network 199. Client 140 may be the source of a video product that is uploaded using a web browser to web server 110 over network 199. Individuals or organizations, known collectively as content posters using one or more clients 140, upload media content they have created to web server 110. The content is viewable through the media player, either through web server 110 and/or and any third party web site or service where the media player is embedded or emailed. At any point before, during or after the media content is displayed, the viewer has the option to use the player to conduct a transaction, in the form of a payment or donation to the content poster using a third party billing service 130, or enter data to facilitate lead generation functions. According to one embodiment, billing service 130 may be PayPal, or similar payment processing service. E-mail service facilitates the sending of e-mails and may be a, QMail, sendmail or other standard SMTP mailer daemon residing on the web or application server(s).

Content delivery system 100 handles one way transactions and two-way transactions using billing service 130. In exchange for a payment or donation made directly to the content poster, a user (e.g. user of client 160) can receive goods, services, media files, access to additional media content, acknowledgment of the money donation or other benefits as determined by the content poster, for example a user of client 140. Providing these goods, services or benefits is the responsibility of the content poster (e.g. user of client 140).

A content poster (e.g. user of client 140) is allowed a customizable storefront, or channel, on the web server 110 through which users can view/listen to media and/or conduct revenue generating transactions or provide contact information regarding one or multiple pieces of content.

The present media player may be embedded into a user's website, enabling an existing organization to display media files without hosting them and conduct transactions, as well as any website that permits third-party embedding. This will enable a user to embed the player on third-party sites including third party web sites and services 150, further extending transaction availability.

Although described as a single web server, web server 110 may have a distributed architecture including media conversion servers, content servers, web servers, and application servers. Media conversion servers may be Linux, Apache Web Server w/PHP utilizing conversion software package. Other UNIX like operating systems such as FreeBSD and MacOS X Server may be used in addition to Linux. Media conversion servers host a media conversion daemon. This server places the converted content onto the content server for usage by the media player. Content servers may be any platform capable of providing HTTP web services, such as Linux/Apache, or Windows/IIS. Content servers host the content to be delivered the media player. The content is placed here by the media conversion service. Content servers may be the hosts for a global caching layer.

Web servers may be Linux, Apache Web Server w/PHP. Web servers may host the main system web site as well as the media player and public interfaces to web services if dedicated API servers are not in use. Application servers may be Linux, Apache Web Server w/PHP. Application servers may optionally host the various data services required by the media player, such as returning the content description, commenting, printing, etc. It is primarily an application interface for the media player.

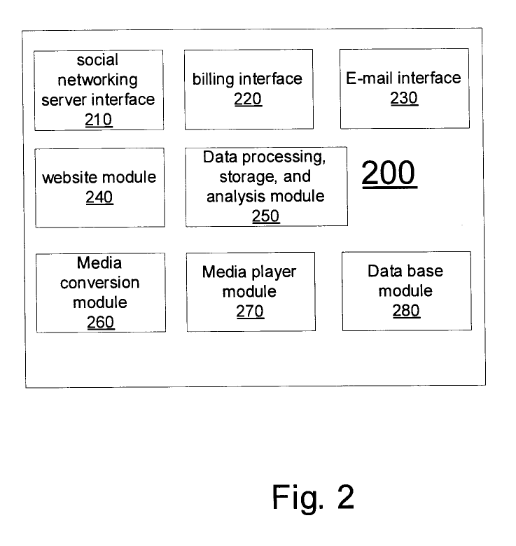

FIG. 2 illustrates an exemplary web server, according to one embodiment. Web server 200 may be web server 110 and includes modules 210-280. Media player module 270 allows users to view media content by playing the audio and video of the content, displaying static images, displaying PDF files or other media presentation formats. According to one embodiment, the web media player is a DHTML/AJAX Web Application (container) using an embedded media player, such as Flash, or other media playback mechanisms as supported on the target platform. The player may be embedded into a web site or email, through which users view media files that content posters have uploaded and through which users have the opportunity to make payment and donation transactions, or perform additional operations, including lead generation. Additionally, a fat client player applications and/or simplified containers will be utilized for content delivery on mobile devices, such as the iPhone, iPod Touch and other mobile platforms.

Before the video is played, the user (e.g. user of client 140) may be presented with a static image selected by the content poster or a system generated thumbnail image of the media content (e.g. user of client 160). A loading image or other graphic may be displayed while the content is being prepared for display. If the content fails to load, then an error message is displayed. According to one embodiment, the media player reads a video file, such as a Flash (“FLV”) file, from the web server 110 using progressive download (HTTP) or streaming (such as RTSP). According to one embodiment, the media player reads an audio file, such as an mp3, file from the server 110. A static graphic or series of graphics, selected by the content poster (e.g. user of client 160), are displayed where there would otherwise be video. According to one embodiment, the media player reads one or more graphics files, such as jpg files, from server 110. An audio file may be played concurrently, as selected by the content poster. According to one embodiment, the media player provides inline display and manipulation of a PDF (Adobe Portable Document File) within the player structure. According to another embodiment, a series of images may be posted for display in the event PDF display is not supported on the target platform. In addition, the player will display other media presentation formats not listed herein.

According to one embodiment, the media player controls the playing of the media file, including: Play/Pause/Seek Forward/Seek Backward/Increase Volume/Decrease Volume/View Full Screen/View Standard Size. A media file can be set to play for a specified amount of time, such as 30 seconds, to act as a trailer for a full-length file that is available upon payment. The seek function can be disabled to ensure continuous playback. Some playback controls may be omitted or modified to conform to UI standards expected on the target device, or to conform to device limitations. According to one embodiment, the media player lists content information including: title, product group, description, total payments or donations, total number of views, the average and number of ratings provided by viewers, statistical information, as well as additional information provided by the content author.

According to one embodiment, the media player authenticates users with the web server 110.

According to one embodiment, the media player allows users to purchase products from and donate to the content provider. This transaction functionality is performed by way of a third-party payment processing service, such as PayPal. Fees and or commissions for services rendered by the system are collected via said third party payment system periodically by the billing service.

According to one embodiment, the media player provides users the ability to distribute the media player through outside services and methods, including email using e-mail interface 230 and embedding the file on other sites (e.g. social networking service interface 210), such as social networking sites, as well as other communication options.

According to one embodiment, the media player includes instructions, answers to common questions and contact info. The media player may provide a user logo direct link, according to another embodiment providing a direct link to the main page in the content poster's channel on web server 110.

According to one embodiment, the media player allows for the generation and sending of an email to an email address supplied by the user using e-mail interface 230. The email contains a direct link for embedding the content currently on display in the player or a video player that, on opening, displays the current media content.

According to one embodiment, the media player allows for the generation of HTML embedding code. The media player provides the HTML code to be used in order to embed the media player, and the cover image for the video the player links to, into a third party site. This code can be copied and pasted by users who are not logged in to the web server (110)

According to one embodiment, the media player provides the necessary information to embed the media player into a social networking site using social networking service interface 210. Third party web sites and services 150 may be social networking services such as MySpace, Bebo, Xing or Facebook.

According to one embodiment, the media player allows users to posts a comment within the media player, regardless of where it is embedded or to the content poster's web site page using website module 240 about this content. The media player also displays a specified number of previous comments for the content. Existing services that permit media file embedding do not permit commenting on embedded files. With this system, all comments are aggregated to the user channel page as well as any other page that it is embedded.

According to one embodiment, the media player allows viewers to rate content on a scale which corresponds to a numeric value. The media player displays an average of ratings from previous viewers as well as the number of ratings received.

According to one embodiment, the media player allows viewers to flag this content as offensive, mature, pirated or otherwise unsuitable for distribution.

Social networking interface 210 allows for media player integration with third party social networking websites. Facebook and other sites have prevented users from embedding third-party Flash applications to avoid the clutter that can occur on MySpace pages. Facebook does allow users to embed YouTube videos on their ‘Share’ sections. The present media player is tailored to Facebook's requirements and allows users to install the media player on their Facebook page. This functionality will be extended to other sites that restrict the embedding of media files.

Data processing, storage, and analysis module 250 supports the present system's web site and media player, and includes the data used for research and reporting, such as data mining, user research, etc. Data processing, storage, and analysis module 250 (split around multiple services, media upload and conversion services) allows for media storage that hosts the uploaded content that is placed by the media conversion daemon and then served to the media player. The converted content is housed on one or more distribution hosts (web servers) or CDNs (Content Delivery Networks). File distribution data is stored in the database 112 and updated as needed to accommodate for redistribution of media assets to allow for load balancing, disaster recovery and a desired geographic distribution spread.

Media conversion module 260 includes a media conversion daemon. Media conversion module 260 converts recently uploaded files from a media conversion service to the appropriate media types used by the media players on various devices. This runs continuously and processes a set number of uploads at a single time. Whenever any conversion finishes, the next file in the queue is processed. Audio files are converted into MP3 or other file formats, and video files will be converted into Flash video (“FLV”) or other file formats. The actual conversion will be completed by an open source application or library, such as FFmpeg with the LAME audio plug-in, or MEncoder. After conversion, the original uploaded file is deleted or archived, at our option, status is updated in the database and distribution to one or more web/content hosts occurs.

Billing interface (220) handles billing for commissions or fees due the system for services rendered. Payment of fees due is performed via a third-party payment collection system such as PayPal, or via credit card.

A billing daemon that is part of billing interface 220 searches for content posters who owe payment for services rendered by the system. This program runs on regular cycles, reviewing every system user's activity and produces an electronic billing statement for collection of fees and/or commission due the system.

Website module 240 enables a user to create an account, upload content for the media player, view content through the player, edit their user settings and view summaries of their ecommerce activity. Website module 240 allows a user to interact with web pages that display recommended content as well as information about the system including news, contact information and other data. Website module 240 allows a user to interact with a registration web page where users create usernames and passwords, and input their email addresses and other account/contact information. Website module 240 allows a user to interact with a user login page where returning users log in with their username and password.

Website module 240 allows a user to interact with an edit user information page. Through the edit user information page, users may update basic user information, including but not limited to e-mail address, user name, legal name, birth date, and gender. Website module 240 allows a user to interact with a payment/billing information page where users add/update credit card, PayPal and other payment services to allow for service billing.

Website module 240 allows a user to interact with a user's channel web page that displays basic user information, including a product list with an associated content list for each product, a video list including thumbnails and summaries of content available, a summary of new messages and links to a messaging inbox, user ratings of the channel and its transaction history, total and itemized payments and donations to and from other users (optional) and content recommended by friends and the system.

Website module 240 allows a user to interact with a product creation page. Through the product creation page, a user specifies the information for products, or services available for purchase, including title, description, optional values such as size and color as relevant, pricing or recommended donation levels, donation goals and other data, or provides data necessary to facilitate collection of lead generation data within the player. A user may associate the product with one or more uploaded media items. Multiple associations are allowed according to one embodiment and no association is explicitly required. The content may be a video, slideshow, audio file, PDF file, or other media format.

Website module 240 allows a user to interact with media upload pages. The media upload pages allow users to upload content to a media conversion web service, and sets initial values for title, description, playback restrictions and other data. Media upload pages provide for the commencement of the conversion process, thumbnail generation and distribution process. Website module 240 allows a user to interact with a product update page. Product update pages update the settings for a product, including: title, description, product customization options, such as size and color, as relevant, pricing/recommended donation levels, donation goals, and other data. Website module 240 allows the user to interact with a media update page. Media update pages update the settings for a piece of media content, including: title and playback restrictions.

Website module 240 allows a user to interact with a channel view page. The channel view page is the main page where visitors to the user's channel land. The channel view page displays user-selected content, including text, graphics, links to sub-pages and opportunities to comment and share the page. Here, visitors view uploaded content through one or more instances of the media player. The content provider can design the page so that lists of comments and transaction amounts or donations associated with the video are presented under the player. The user channel page also displays recommended and featured content from other areas of the system, as well as ratings from other users of their experience making purchases from this channel.

Website module 240 allows a user to interact with a view video page that is the page where users following a link to a poster's video content land. The view video page displays user-selected content, including text, graphics, links to sub-pages and opportunities to comment and share the page. Here, visitors view uploaded content through one or more instances of the media player.

Website module 240 allows a user to interact with a recommended and featured content page. On the user's storefront or profile home page hosted on website 110, content delivery system 100 can automatically embed links to additional content. This content could be both recommended content, targeted to user preferences, and featured content, driven by advertisers.

Website module 240 allows a user to interact with a payment account page where users can transfer money into a payment account and then have their transaction amounts withdrawn from that account. Through this, credit card fees are only applied to the initial transfer. Subsequent payments or donations from this fund to other users will not incur credit card fees. The payments are for values that are stored in the stored value account. The transfer of funds is preformed through a third party payment system, such as billing service 130.

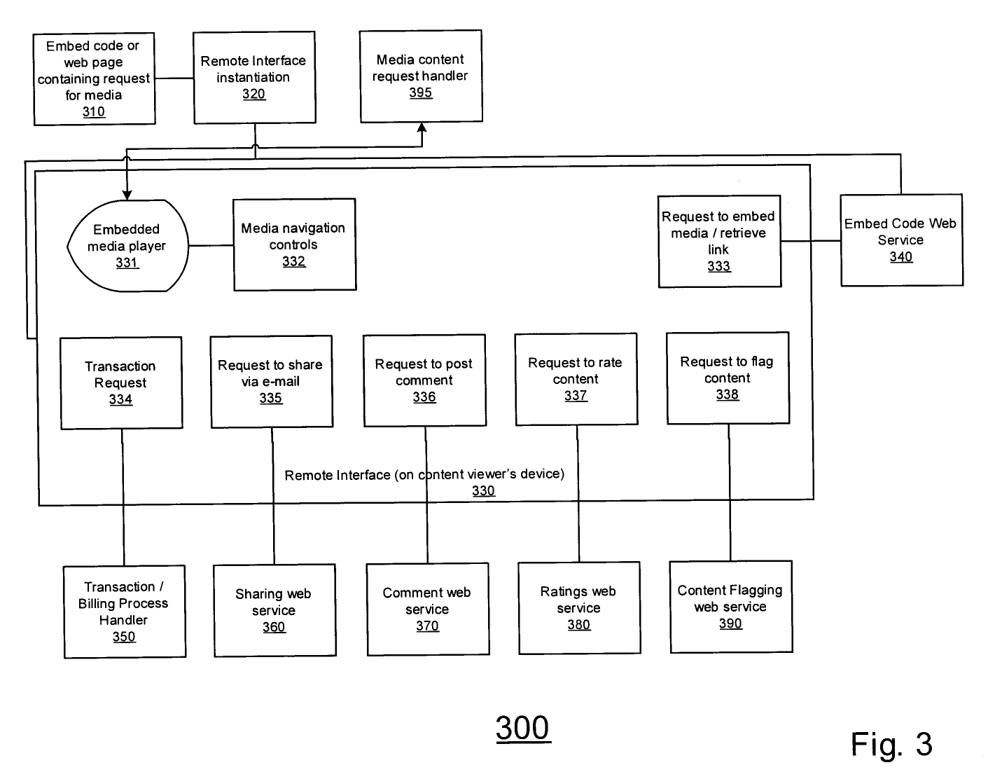

FIG. 3 illustrates an exemplary media player functionality, according to one embodiment. A media player is available to users of system 100 (e.g. a user of client 160) as a remote interface 330 presented on client 160. Remote interface 330 is a top level container housing all functionality required to facilitate the playback or interaction with the media presented, perform transactions, view and post comments, as well as other functionality related to the media content displayed. It may be a web-based structure (DHTML/AJAX), a fat client application or a similar structure to conform to the requirements of client 160.

Presentation of remote interface 330 occurs by providing embedded code 310 to a web site such as third party web sites and services 150. Embedded code 310 may also be a web page containing a request for media. Embedded code 310 provides a gateway for the instantiation of the remote interface 330 (media player). Embedded code 310 may be located inside or outside the system and contains a reference to the media requested. By communicating with third party web sites and services 150 through the embedded code 310, web server 110 instantiates the media player 330 using a remote interface instantiation process 320. During process 320 the nature of the remote interface's host device (e.g. client 160) is determined. Then process 320 performs either of the following:

(1) The web server 110 (or web services) generate and transmit, via the internet or other data network 199, an appropriate version of the media player 330 for display by the user's client 160; or
(2) launches a remote interface 330 that has been locally installed on the user's client 160.

Embedded media player code 331 executes on client 160 to generate the embedded media player 330. Embedded media player code 331 is a component used to facilitate the display of media on client 160. Example components include but are not limited to: Flash or QuickTime for the display of video media, Adobe Acrobat Reader to facilitate the display of PDF (Portable Document File) media or other custom built components to facilitate delivery of other media types.

Through the media player 330, interactions with web services of web server 110 are performed. The web services may include embed code web service 340, transaction/billing process handler 350, sharing web service 360, comment web service 370, ratings web service 380 and content flagging web service 390. According to one embodiment, transaction/billing process handler 350 audits the transactions performed to generate billing due to web server 110 by the content poster (e.g. user of client 140), but does not process the financial transaction.

Embed code web service 340 is a web service residing on an application or web server, which provides embeddable HTML code and or links to facilitate the distribution of the media player 330 with web sites and services. Transaction billing process handler 350 executes a process which audits transactions or other billable services rendered by the service for later collection. Sharing web service 360 is a web service residing on an application or web server which provides a facility for the distribution of e-mails, or other electronic messages to share links or other associations to media player 330 with other users.

Media content request handler 395 is the process that provides data, in the form of SMIL or other formats, to the media player to access media resources stored on the content hosts.

Comment web service 370 is a web service that facilitates the posting of comments associated with the media content displayed and may include agents to filter content or delay posting of said content pending approval from the content poster. The current system permits users who view remotely embedded content to add comments that are aggregated to the media file's primary viewing page (eg. a user channel on web server 110) and then viewable wherever the content is embedded. Ratings web service 380 is a web service that facilitates the rating of media content, users and other content using ratings counts and aggregation. It may provide a current ratings/count as well as aggregate new ratings. Ratings web service 380 may include logic to prevent abuse of the rating system, including but not limited to IP address logging and comparisons between time of ratings and content delivered.

Content flagging web service 390 is a web service that facilitates the flagging of content (media or otherwise) as inappropriate, vulgar, violating copyright or other similar conditions. Content flagging web service 390 facilitates the alert of and potential removal of content that may violate copyright or is inappropriate for display.

Media player 330 includes media navigation controls 332. Media navigation controls 332 are user interface elements that enable control of the display of media delivered by the embedded media player 331. Media navigation controls 332 may include, but are not limited, to play, pause, review (rewind), cue (fast forward), and page up, page down, and zoom (for PDFs, images, etc.) controls.

Media player 330 includes a number of user interface elements that are request modules 333-338. Embed Media/Retrieve Link request module 333 initiates and display the results of a data transaction between the medial player 330 and the embed code web service 340. Transaction request module 334 initiates an e-commerce, lead generation or other transaction function. Transaction request module 334 is displayed when the user requests to purchase a product or service for sale.

Share via e-mail request module 335 initiates and displays the results of a data transaction between the media player 330 and sharing web service 360. Post comment request module 336 initiates and displays the results of a data transaction between the container 330 and comment web service 370. Content rating request module 337 initiates and displays the results of a data transaction between the media player 330 and ratings web service 380. Content flagging request module 338 initiates and displays the results of a data transaction between the media player 330 and content flagging web service 390.

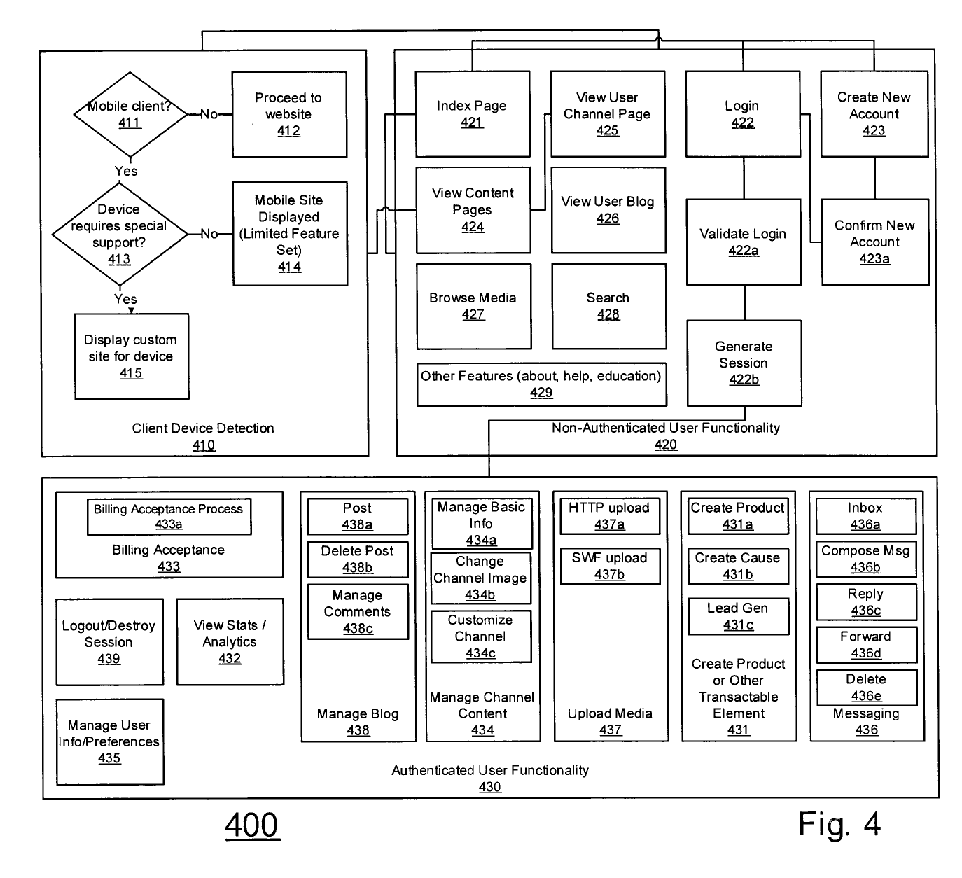

FIG. 4 illustrates an exemplary web site functionality, according to one embodiment. Website functionality 400 includes client device detection 410 that determines what content to display (desktop, mobile, iPhone, etc) and a collection of web pages that are either publically available (non-authenticated user functionality 420) or access restricted (authenticated user functionality 430).

Client device detection process 410 determines if the current viewer's device (e.g. client 160) is capable of displaying the complete website 412. If it is not, client device detection process 410 redirects the client device 140 to content appropriate for client device 140. Non-authenticated user functionality 420 is a group of functions provided to all visitors of the website, regardless of their authentication (login) state. Authenticated user functionality 430 is a group of functions provided only to authenticated users of the website. Authenticated users are individuals or organizations who have created and maintain an account in good standing and have provided the appropriate credentials to authenticate that account.

Client device detection process 410 determines if client 160 is a mobile client. (411) If client 160 is a not a mobile client, client 160 is connected to the website. If client 160 is a mobile device, the process 410 determines if the mobile device needs special support. (413) If no special support is required, a mobile website is provided to client 160 having a limited feature set when compared to the website available to non-mobile devices. (414) If special support is required, a custom mobile website is provided to client 160.

Non-authenticated user functionality 420 includes the following:

Index page 421 is the index (e.g. home) page, which is the first page displayed upon entering the website 110. It may contain suggested content, company information, educational elements and navigation functions that persist throughout the site.

Login 422 is the code used to generate a user interface on client 160 by which the user attempts to login (authenticate) and create a session to access authenticated user functionality.

Validate login 422a validates the data provided by the user in login 422 based upon any of a number of authentication methods. Login credentials are validated against account data securely stored in the database.

Generate session 422b generates a session which is used among other purposes, as a token indicating an authenticated user.

Create new account 423 is the code used to generate a user interface on client 160 for facilitating the creation of a new account within system 100.

Confirm new account 423a is a process that validates the data provided in create new account 423 and proceeds to the login function 422 to allow the user to access authenticated user functions via their newly created user account.

View content pages 424 is the code used to generate and present a collection of pages on client 160 that serve as a container for the instantiation of the media player 330 allowing for the display of media content and associated functionality within the website 110.

View user channel page 425 is the code used to generate and present a web page or collection of web pages on client 160 that allows users to view the channel pages of registered users which contain media and transactable items, information about the user and other data which is customizable by the owner of the account to which the channel page is attached.

View user blog 426 is the code used to generate and present a web page or collection of web pages on client 160 that allows the user through client 160 to view weblogs (blogs) which contain content posted by the author of the blog. These pages may also allow for comments, flagging and other features related to the content of the blog, and provide RSS feeds of the content available.

Browse media 427 is the code used to generate and present a web page or collection of web pages on client 160 that allow the user through client 160 to browse through media available in the system that has been posted by users and may include features to refine the results displayed, such as filters, sort mechanisms and other similar devices.

Search 428 locates specific content within the system using keyword, parametric, lexical search or other methods.

Other features 429 is a collection of other features that facilitate the use of the website 110 and provide basic information and services to users. These features may include educational elements, about pages, terms of service, contact pages and other content.

Authenticated user functionality 430 includes the following:

Create product or other transactable element 431 is the process by which users create products, services or other transactable elements for display within system 100. These products may include physical or electronic goods, or the collection of data to facilitate lead generation.

Create product module 431a collects data to facilitate the creation of a product or service for sale from the content poster to the end user (viewer). Create cause module 431b collects data to facilitate the creation of a cause to which donations may be transferred from the end user (viewer) to the content poster. Lead generation module 431c collects data to facilitate the creation of a lead generation data collection form (or other entry method) in which data desired by the content poster may be collected from the end user (viewer) and delivered to the content poster.

View statistics/analytics 432 is the code used to generate a user interface on client 160 by which content posters may view statistical and derived analyses to track content viewership patterns, audience behavior, transaction success and similar data.

Billing Acceptance 433 are the billing acceptance page(s) which incorporate a billing acceptance process and other elements to allow for payment of funds due for services rendered by system 100.

Manage channel content 434 is the code used to generate and present a web page or collection of web pages on client 160 by which an authenticated user may update content on their customizable channel page. These pages may include, but are not limited to the following features (434a-434c):

Manage Basic Info 434a—This allows for editing of basic channel information such as the channel title, description.
Change Channel Image 434b—Allows the user to change or create an image that allows for branding of the channel or identification of the channel's purpose. This image is created and provided by the channel owner.
Customize Channel 434c—This allows the user to customize the appearance and content of portions of the channel page. This customization may be accomplished by, but not limited to a WYSIWYG (What You See Is What You Get) editor.

Manage user info/preferences 435 allows the user to update user information and set preferences in the system, such as changing e-mail addresses, contact preferences, or updating passwords.

Messaging 436 is a messaging system that is used for internal communications, system notices and other features of the system. It may but is not required to send and receive messages using SMTP e-mail. Messaging 436 includes:

Inbox 436a that is the facility for viewing the headers of messages to select them for display or other actions;
Compose message 436b that allows for the composition of a new message to another (or multiple) users of the system;
Reply 436c that allows the sending of a reply to the originator of the message or to all recipients of and the originator of the message;
Forward 436d that allows the forwarding of the message to other user(s) of the system; and
Delete 436e that allows for the removal of messages no longer needed or wanted by the user.

Upload media 437 is the process by which media is uploaded for use on system 100. The uploaded media is later processed by a media conversion process, distributed, and then viewed using the media player 300. Upload media 437 includes:

HTTP upload process 437a that uploads media using HTTP uploads (a standard method supported by most web browsers and other systems); and
SWF upload process 437b that uploads media using a SWF (Adobe Flash) component used to make the upload process more tolerant of network issues and generally more robust.

Manage blog 438 is the process by which authenticated users manage content posted in their user blog, which is viewable in view user blog 426 and includes but is not limited to the following features:

Post 438a that allows the user to post new content to the weblog using a web interface and may also be made available via REST APIs;
Delete post 438b allows the user to delete a posting to the blog that they have created; and
Manage comments 438c allows the user to manage comments posted to his/her blog entries, including but not limited to: approval for display, delete comment, and flag comment.

Logout/destroy session 439 is the process by which the user terminates his/her session to log out of the system and prevent unauthorized access of authenticated user functionality via client 160 used to log in (authenticate) to system 100. After selecting this option, the user must re-authenticate before being allowed access to authenticated user functionality 430.

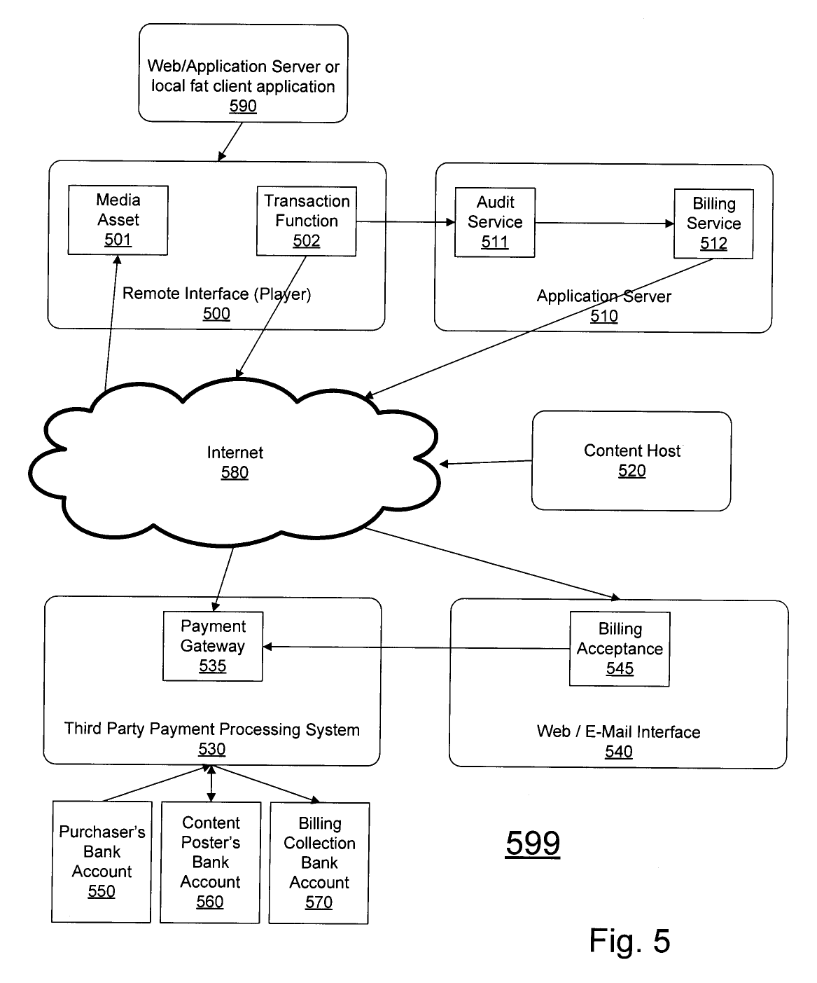

FIG. 5 illustrates an exemplary billing system and payment process, according to one embodiment. Financial transaction system 599 includes a media player 500 that may be media player 330. Media player 500 includes a media asset 501 being displayed and embedded elements including the transaction function 502 and necessary additional elements to describe the transaction being initiated. A media asset 501 is the media asset being displayed within the media player 500 and may be, but is not limited to video, audio, images or textual media. Transaction function 502 is the transaction function within the media player 500 and provides a facility for the collection of data for transmittal to the third party payment system 530 and audit service 511 for the completion of a transaction between the content viewer (e.g. user of client 160) and the content poster (e.g. user of client 140).

Financial transaction system 599 includes an application server 510 that is an application/web server to facilitate the operation of the audit service 511 and billing service 512 which allow for the collection of funds due for billing of services rendered via the media player 500. Audit service 511 is an audit service that records transaction function actions to produce a billing record which drives the billing acceptance function 545. Billing service 512 is a daemon that generates the actual “invoices” which the content poster will pay. It gets its data from the audit service 511 that logs every billable action and is accepted in process 545 and paid by way of a third party payment processing system 530.

Content host 520 provides data necessary for the delivery of media assets to media player 500.

Third party payment processing system 530 allows for transfer of funds between the bank accounts of various parties involved in the transaction and billing processes. Third party payment processing system 530 may be PayPal or other similar payment system. Third party payment processing system 530 includes payment gateway 535 that is the external gateway interface, typically a REST (Representational State Transfer) API or similar interface to accept and process data to initiate a transfer of funds between two parties.

Web/e-mail interface 540 is a web or e-mail based interface to facilitate the payment of funds due to satisfy billing for services rendered by the service. These payments are in turn processed by the third party payment processing system 530.

Third party payment processing system 530 accesses a purchaser's bank account 550. Purchaser's bank account 550 is the purchaser's (content viewer's for example, user of client 160) bank account or similar device from which funds are debited by the third party payment processing system 530 to facilitate the payment of the content poster upon completion of a transaction via the media player 500 for goods or services provided to the purchaser (content viewer).

Third party payment processing system 530 accesses a content poster's bank account 560. Content poster's bank account 560 is the content poster's bank account, or similar device, to which funds are credited by the third party payment system 530 to complete a transaction performed via the remote interface. Additionally, content poster's bank account 560 may serve as the source for funds transferred to the billing collection bank account 570 by the third party payment processing system 530 to satisfy billing due for services rendered by the system.

Third party payment processing system 530 accesses billing collection bank account 570. Billing collection bank account 570 is the billing collection bank account which serves as the recipient account for funds received by the third-party payment system 530 to satisfy fees due for services rendered by the system.

Financial transaction system 599 is interconnected by a network 580. Network 580 may be the internet or other public switched data network through which data is transmitted between various processes and components of the system, a third-party payment processing system and the users thereof.

Financial transaction system 599 includes web application server 590 that is a web/application server or local fat client application which causes the instantiation of the media player 330/500 and may consist of HTTP data exchange, local code executed to instantiate the remote interface or other methods to accomplish the task of instantiating the remote interface.

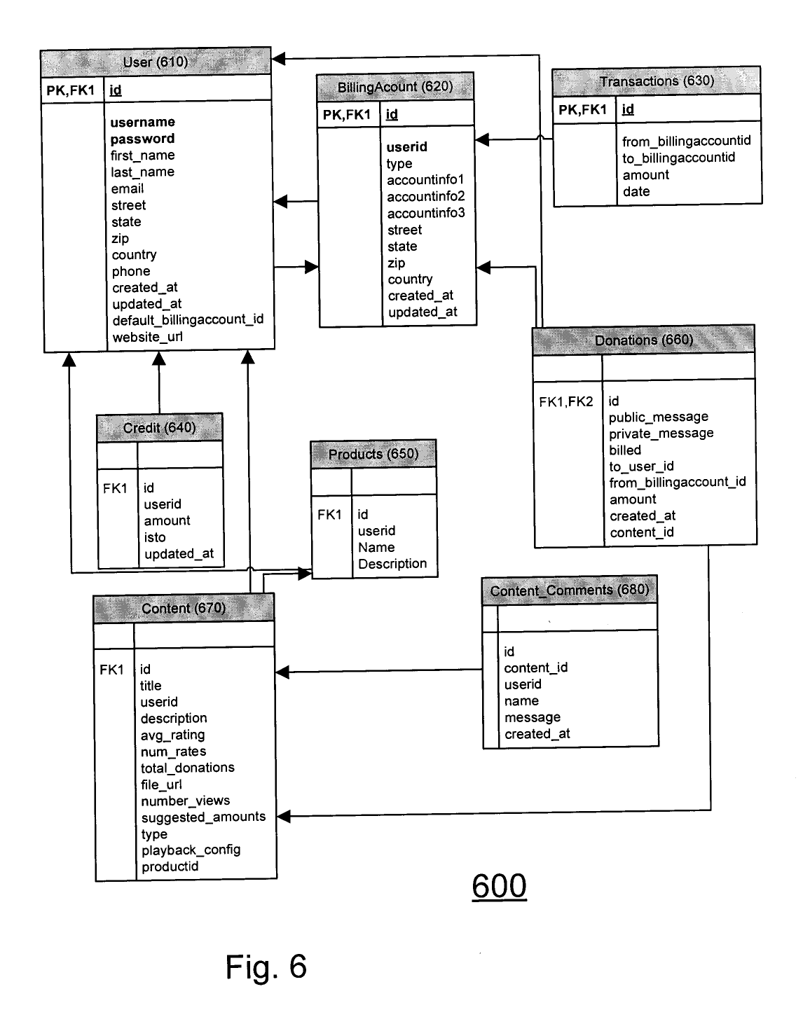

FIG. 6 illustrates an exemplary database schema, according to one embodiment. User table 610 stores basic user information (e.g. username, email, etc.) and forms the basis of a user account, thus identifying users of the system. A billing account table 620 contains all billable accounts and the associated information to be used for transactions. A user may have more than one billing account. If there is no user account available for a transaction, the user must create one. This functionality also houses the account information for the system itself. Billing account table 620 stores data used by the billing process to allow for the transfer of funds to the system billing bank account for the payment of fees for services rendered by the system. Additionally this data may be used for refunds to the user in the event refunds are necessary.

A transaction audit table 630 provides a history of all transactions on the present system, including: amount, date, contentID, productID, and the billing data involved. Transaction audit table 630 stores a running record of transactions performed against the accounts stored in the billing account 620 and stores the amount owed from any one given user to another user within the system 100. This data may be used to drive the payment and billing systems. One of these entries also tracks the transaction and storefront fees each poster owes to the present system.

An order form table contains data to generate the transaction forms within the player when combined with user entered data. A product table 650 stores all product groups and associated information. A donations table 660 used to drive billing for donation services rendered by the system and for reporting and analytical purposes. A public content table 670 stores references to media content to be displayed in media player 330. Public content table 670 stores the details of a specific piece of publicly viewable content: location, title, conversion status, product group, etc. A content comments table 680 stores the accumulated comments posted by users for a specific piece of content.

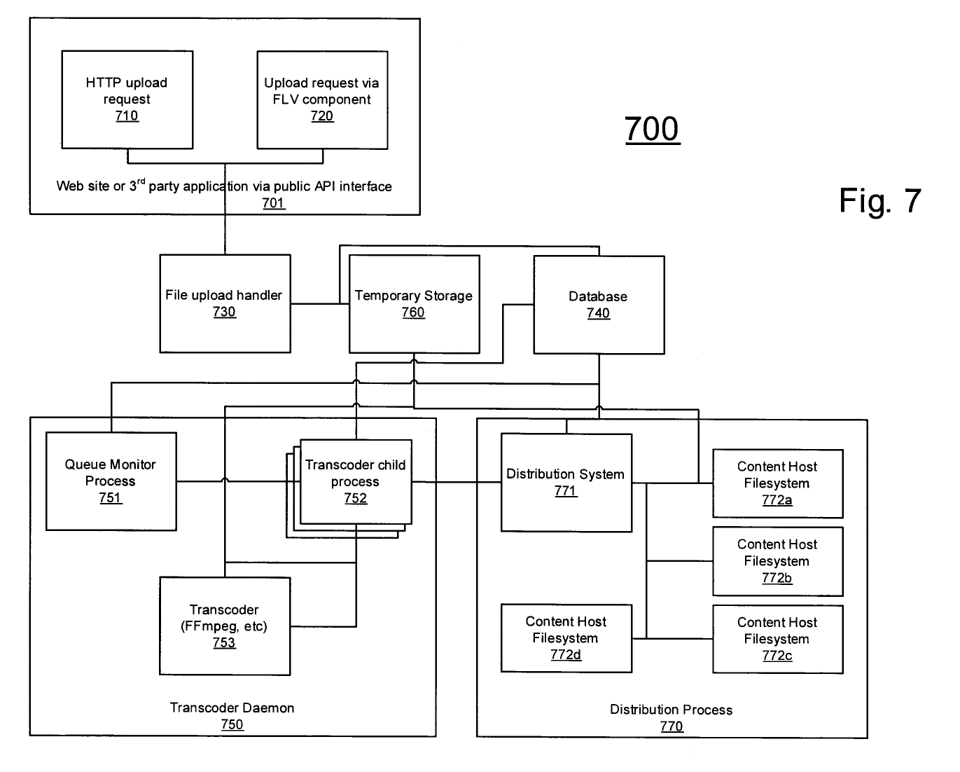

FIG. 7 illustrates an exemplary content conversion functionality, according to one embodiment. Content conversion module 700 may be implemented by media conversion module 260 of web server 110, according to one embodiment. Content conversion module 700 includes a web site or third-party application using a public API 701. This is a system web site, or application via an externally accessible interface, which provides a method for data transfer. It facilitates the delivery of the content poster's media files or data for transcoding or conversion and their eventual delivery to media player 330 for use by the content viewer.

Web site/API 701 includes, but is not necessarily limited to HTTP upload request 710 and upload request via FLV component 720. HTTP upload request 710 that facilitates the transfer of the unaltered media asset to the file upload handler 730. Upload request using FLV component 720 facilitates transfer of unaltered media assets to the file upload handler 730.

File upload handler 730 negotiates the request for transfer of data from website/API 701. File upload handler 730 may, but is not required to, perform the functions of error correction and reporting of status or completion. File upload handler 730 places the data received into temporary storage 760 for use by other processes and inserts or updates data in the database 740 for use elsewhere in the system 100.

Database 740 is a database, such as a collection of data structures contained in an RDBMS (relational database management system), such as MySQL or PostgreSQL, which stores data for rapid access by other elements of the system and enforces structural and referential integrity of the stored data.

Transcoder daemon 750 is a constantly running process that monitors for media assets in need of transcoding or processing and performs needed actions using a queue monitor process 751, a transcoder child process 752 and a transcoder 753. Transcoding daemon 750 uses a multithreaded approach to control server resource utilization and, as such, may occur at some time later than the completion of the interaction between the web site (or third-party application via public API interface) 701 and the file upload handler 730. Transcoding daemon 750 executes a queue monitor process 751 that monitors a queue of media assets in need of transcoding using queries against the database 740. Transcoder child process 752 is a process or thread created on the host of the transcoder daemon 750 that performs the actions of transcoding the media uploaded by the content poster via website/API 701. The media is transcoded using transcoding engines 753 that may be used multiple times to provide support for various target platforms and network conditions. Transcoder 753 (e.g. FFmpeg, etc.) is one or more transcoding engines that perform the actual conversion of media assets, and include, but are not limited to, FFmpeg, LAME, MEncoder, SOX and similar applications, libraries or services.

Content conversion module 700 includes temporary storage 760 for files stored in a file system on a server, in binary large object (BLOB) fields in a database or in a RAM cache. In this implementation, temporary storage 760 stores data received by the file upload handler 730 for transcoding/conversion as needed by the system 100.

Content conversion module 700 includes distribution process 770 that facilitates the distribution of converted media assets to various content servers 772a-d to satisfy load and geographic needs. Distribution process 770 includes distribution system 771 that receives files from the transcoder daemon 750, and distributes them to content servers 772a-d and, in turn, updates data in the database 740 used to locate these files. Content host file systems 772a-d are content hosts (web servers), upon whose file systems the distributed content is placed.

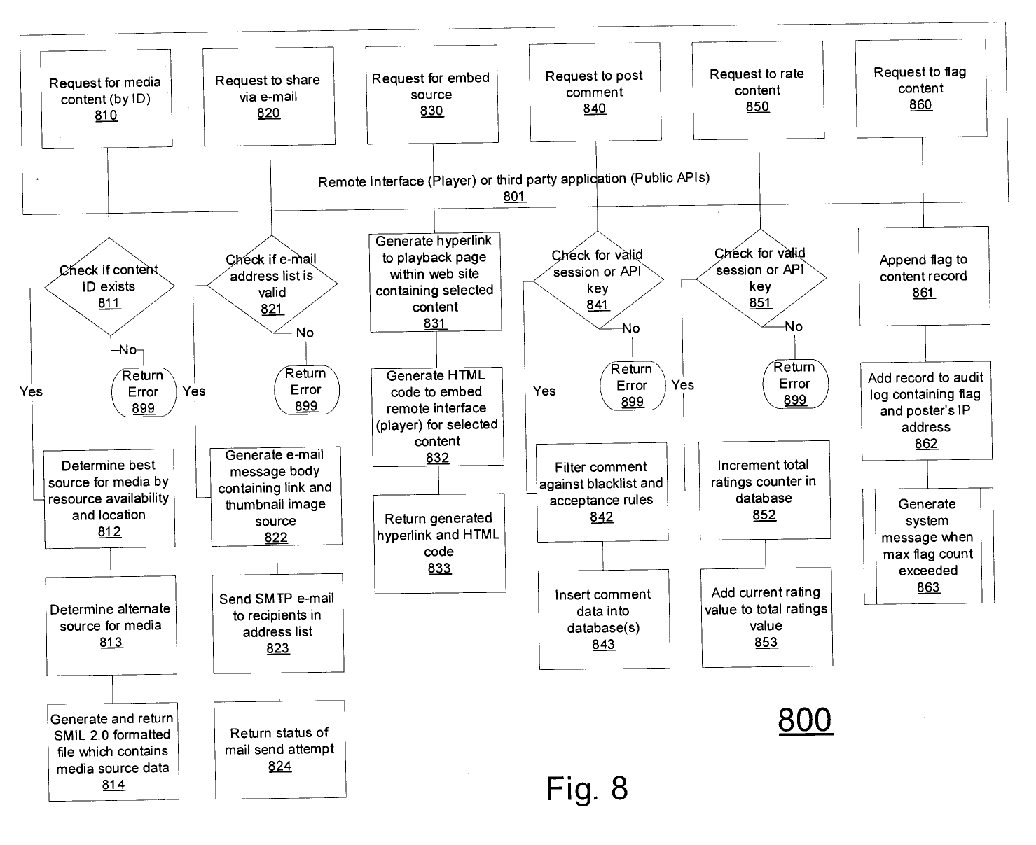

FIG. 8 illustrates exemplary application server logic, according to one embodiment. Application server logic 800 handles request originating from medial player 330 and/or third party applications through the system's API 801.

Application server logic 800 handles a request for media content (by ID) 810. Media content request 810 is a request by media player 330 for media assets to be displayed on client 160. This request is processed by checking the validity of the content ID passed (811). If the content does not exist, an error is returned (899). If the content exists, the best sources for the media are determined (812). An alternate source for the media is determined (813). A SMIL file is generated which is used by media player 330 to begin transfer of data to display said media via various methods including progressive download or streaming (814).

Application server logic 800 handles a request to share content via e-mail 820. Content share request 820 is a request to share content vie e-mail or similar electronic messaging systems. A list of e-mail addresses is checked for validity (821). If the e-mail addresses are not valid an error message is returned (899). If the e-mail addresses are valid, a message containing data to access the media is generated (822). An electronic message is sent to recipients specified by the e-mail addresses (823). The status of the delivery attempt is returned (824).

Application server logic 800 handles a request for embed code 830. Embed code request 830 is a request for the generation of HTML or similar code to embed media in a website or system. The web service is provided an identifier to the media (831). HTML code to embed media player 330 is generated (832). A hyperlink and HTML code is returned to the requester (833).

Application server logic 800 handles a request to post comments 840. Comment posting request 840 is a request to post a comment associated with the media asset or other content element within system 100. The request is generated from the media player 330 (or other point of origin). Comment posting request 840 checks the validity of a session or API key to prevent abuse of the comment system. If not valid, an error message is returned (899). The content is filtered for profanity, HTML code and other prohibited elements (842). Content data is inserted into a database or other data store (843).

Application server logic 800 handles a request to rate content 850. Content rating request 850 is a request to rate content. Content rating request 850 checks the validity of a session or API key to prevent abuse of the comment system. If not valid, an error message is returned (899). The (numeric) rating received by the service is added the current rating value and the rating count is incremented in the database (852). The current rating value is then divided by the rating count to provide an overall rating (853).

Application server logic 800 handles a request to flag content 860. Content flagging request 860 is a request to append a flag to an element of content (media or otherwise) stored within the system (861). These flags are use to indicate potential copyright or usage violations such as obscenities. The flag request and data identifying the source of the flag is received by the web service and stored in the database (862). If the flag count for a specific content element exceeds a given threshold, a system message is generated and or the content is automatically made unavailable for use (863). IP filtering or other methods (such as comparisons with view data) may be used to prevent abuse of the flagging system.

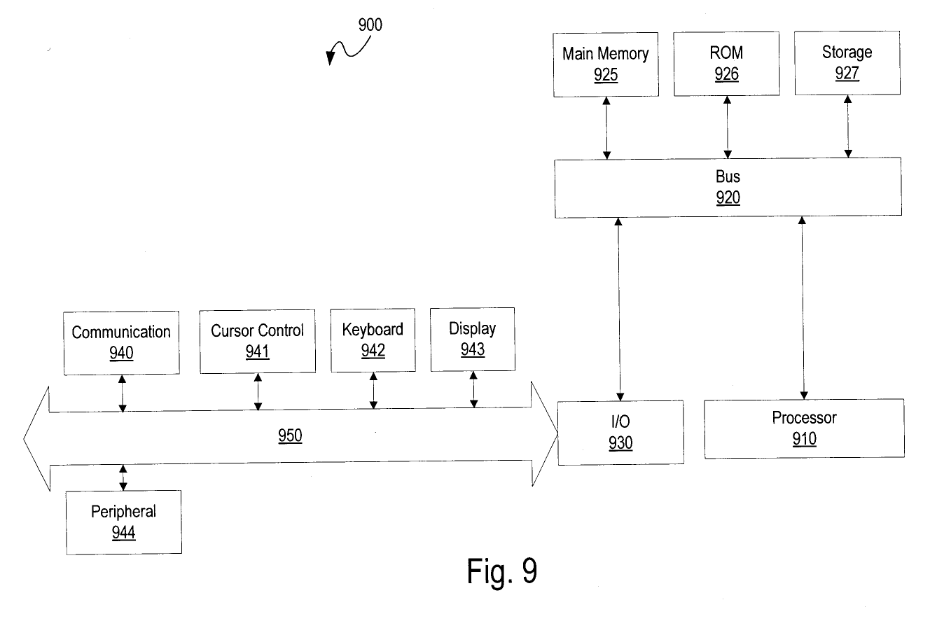

FIG. 9 illustrates an exemplary computer architecture 900 for use with the present system, according to one embodiment. The computer architecture 900 may be used to implement a content system 100 with all or a part of the components shown in FIG. 1. One embodiment of the architecture 900 comprises a system bus 920 for communicating information, and a processor 910 coupled to the bus 920 for processing information. The architecture 900 further comprises a random access memory (RAM) or other dynamic storage device 925 (referred to herein as main memory), coupled to the bus 920 for storing information and instructions to be executed by the processor 910. Main memory 925 also may be used for storing temporary variables or other intermediate information during execution of instructions by the processor 910. The architecture 900 also may include a read only memory (ROM) and/or other static storage device 926 coupled to the bus 920 for storing static information and instructions used by the processor 910.

A data storage device 927 such as a flash memory, a magnetic disk or optical disc and its corresponding drive may also be coupled to the computer system architecture 900 for storing information and instructions. The architecture 400 can also be coupled to a second I/O bus 950 via an I/O interface 930. A plurality of I/O devices may be coupled to the I/O bus 950, including a display device 943, an input device (e.g., an alphanumeric input device 942 and/or a cursor control device 941).

The communication device 940 allows for access to other computers (servers or clients) via a network. The communication device 940 may comprise a modem, a network interface card, a wireless network interface or other well known interface device, such as those used for coupling to Ethernet, token ring, or other types of networks.

The present system provides multiple APIs, such as API based Web Services framework, language dependent API, and language independent API. The APIs provide programmatic access to the present services.

The Web Services API is based on Web Services framework, which can include the Simple Object Access Protocol (SOAP), Web Services Definition Language (WSDL), and the XML Schema Definition language (XSD).

The present system's web services are a combination of client-side and server-side components, and may include schemas, hardware servers, software servers, and other components and services.

### Software/Framework Considerations

The software foundation of the system is LAMP architecture (Linux, Apache, MySQL, PHP) with additional server side components developed in Perl and GCC. Client side functionality is implemented using a combination of AJAX, JavaScript, and Flash, as well as other fat-client development languages (such as objective C or Java) as required for platform support.

The website and web services are primarily written in PHP 5 with some elements requiring the GD graphics library and a recent MySQL database.

The daemons reuse the database objects, and are primarily written in Perl 5 using a multithreaded (forked) approach. In addition to a constantly running compression daemon, a watchdog process (executed via a cron event) monitors the compression daemon, restarting it if required.

The media players will be developed as AJAX, HTML/XHTML, WHTML or fat client (native) containers presenting one of many video playback plug-ins as available on the target platform, including but not limited to Flash, Silverlight, Windows Media Player, Real Player, QuickTime and various 3GPP player mechanisms included in the application stacks of various mobile devices.

FFmpeg w/LAME, or MEncoder—Open source programs that are able to convert a large number of video and audio containers and codecs to almost any other codec and container format, known commonly as transcoding. These programs are utilized by the media conversion daemon for the conversion of the uploaded media files. FFmpeg handles video well, but it needs an audio plug-in, LAME, to work with the MP3 audio format that is part of most video files. Additionally, FFmpeg is used for the generation of still images to drive the thumbnail creation process. MEncoder is used as an optional conversion utility to augment the feature set of FFmpeg. Additional conversion utilities and libraries may be integrated as new video formats become necessary to support, or to improve the performance and compatibility of the transcoding process.

Payment Mechanisms—A third-party service capable of handling billing transactions. Payments to content posters are made via PayPal, credit cards and direct transfer to bank accounts. The system stores records of these transactions, separate from records generated by the third-party payment system. This service is utilized by the billing web service and the billing daemon.

The present system 100 can be instantiated on cell phones, computers or other apparatus, set-top boxes, handheld, kiosks, etc. Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments of the invention also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The web servers 110, 120, 130, 150, and 160 may be any commercially available web server programs such as the Apache Server for UNIX or ligHTTPd.

According to one embodiment, database 112 is defined by a hierarchical structure of classes. The objects of these classes represent the knowledge information that includes, inter alia, user profiles (including knowledge profiles) and organizational structure. Database 112 contains profile and repository information and can use one of a number of commercial relational database management systems. According to one embodiment web server 200 includes a database interface that provides a logical database-independent class API to access the physical databases and to shield the complete server codes from accessing database native API so that the server process can use one of many database management systems (RDMS).

Database 112 is built on a general purpose relational database management systems and provide persistent storage for the core system classes referred to above. In one exemplary embodiment of the present invention, database 112 is implemented utilizing the MySQL server, developed by MySQL AB., to provide default storage management services for the system. However, programming may be done at a more general level to allow for substitution of other production class relational database management systems, such as those developed by Sybase, Oracle or Informix.

In one exemplary embodiment, web browser clients may comprise the Internet Explorer client developed by Microsoft Corp. of Redmond, Wash., or the Mozilla Firefox client developed by Mozilla Corporation of Mountain View, Calif. Each of the e-mail clients may further comprise the Outlook Express, Outlook 97, Outlook 98, Mozilla Thunderbird or Apple Mail e-mail programs.

A system and method for distributing media content and processing payments have been described. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method, comprising:
receiving a request to view a media content;
providing a trailer associated with the media content for display on a remote client;
providing an interface on the remote client for initiating a request to transfer money and information to the poster of the media content.

2. The computer-implemented method of claim 1, wherein money includes payments and donations.

3. The computer-implemented method of claim 1, wherein information includes sales lead generation information.

4. The computer-implemented method of claim 1, wherein information includes comments, wherein the comments are aggregated from a plurality of instantiations of a media player displaying the media content to a plurality of remote clients.

5. The computer-implemented method of claim 4, wherein the media player is embedded on a plurality of websites.

6. The computer-implemented method of claim 1, further comprising receiving a subscription to goods and services.

7. The computer-implemented method of claim 1, further comprising providing podcasts to the remote client that feature e-commerce functionality.

8. The computer-implemented method of claim 1, further comprising providing a blogging interface on the remote client, and an RSS feed interface on the remote client.

9. The computer-implemented method of claim 1, further comprising providing the media content to the remote client, wherein the media content includes at least one of a text document, an image, a PDF, audio file, a video file, a MIDI file, and a software file.

10. The computer-implemented method of claim 1, wherein the media content relates to goods and services.

11. A computer readable medium having stored thereon a plurality of instructions, sand plurality of instructions when executed by a computer, cause said computer to perform:
receiving a request to view a media content;
providing a trailer associated with the media content for display on a remote client;
providing an interface on the remote client for initiating a request to transfer money and information to the poster of the media content.

12. The computer readable medium of claim 10, wherein money includes payments and donations.

13. The computer readable medium of claim 10, wherein information includes lead generation information.

14. The computer readable medium of claim 10, wherein information includes comments, wherein the comments are aggregated from a plurality of instantiations of a media player displaying the media content to a plurality of remote clients.

15. The computer readable medium of claim 14, wherein the media player is embedded on a plurality of websites.

16. The computer readable medium of claim 10, having stored thereon-additional instructions, said additional instructions when executed by a computer, cause said computer to further perform receiving a subscription to goods and services.

17. The computer readable medium of claim 10, having stored thereon-additional instructions, said additional instructions when executed by a computer, cause said computer to further perform providing podcasts to the remote client that feature e-commerce functionality.

18. The computer readable medium of claim 10, having stored thereon-additional instructions, said additional instructions when executed by a computer, cause said computer to further perform providing a blogging interface on the remote client, and an RSS feed interface on the remote client.

19. The computer readable medium of claim 10, having stored thereon-additional instructions, said additional instructions when executed by a computer, cause said computer to further perform providing the media content to the remote client, wherein the media content includes at least one of a text document, an image, a PDF, audio file, a video file, a MIDI file, and a software file.

20. The computer readable medium of claim 10, wherein the media content relates to goods and services.
